(19) United States
(12) Patent Application Publication
(10) Pub. No.: US 2025/0193145 A1
(43) Pub. Date: Jun. 12, 2025

(54) IP ADDRESS ALLOCATING APPARATUS AND METHOD USING AN ENCODING OF DISJOINT INTERVALS

(71) Applicant: ARABIAN GULF UNIVERSITY, Manama (BH)

(72) Inventors: Adel BOUHOULA, Manama (BH); Mohamed-Bécha KAÂNICHE, Manama (BH)

(73) Assignee: ARABIAN GULF UNIVERSITY, Manama (BH)

(21) Appl. No.: 18/533,035

(22) Filed: Dec. 7, 2023

(51) Int. Cl. H04L 61/2503; H04L 45/74; H04L 61/5007; H04L 101/668

(52) U.S. Cl. CPC H04L 61/2503; H04L 45/74; H04L 61/5007; H04L 2101/668

(57) ABSTRACT

A method and system provide a BKAS addressing scheme. The scheme enables the encoding of disjoint intervals in each addressing block of an IPv6/IPv4 address. This scheme permits a better flexibility in IP packet matching and an improved implementation of security policies by highly compressing the number of rules and offering much more expressivity in their semantics. This simplifies the configuration of security and network devices while significantly reducing the configuration anomalies. Furthermore, an efficient matching algorithm and a set of transitional methods are also provided. A BKAS design strategy for network subnetting is also provided, allowing for the elimination of all overlaps in the configuration rules of network and security devices while avoiding a combinatorial explosion of the number of configuration rules. The BKAS addressing scheme can be included in any hardware and software program.

### TECHNICAL FIELD

The broad domain of this invention is ICT networking and cybersecurity. More precisely, it relates to IP addressing schemes. In particular, the invention defines a novel addressing scheme using an original disjoint address interval encoding alongside an efficient IP packet matching mechanism and transitional methods ensuring transition from the established addressing scheme CIDR/VLSM.

### BACKGROUND

Invented by Phil Karn in the eighties of the previous century, the CIDR (Classless Inter-Domain Routing) notation has revolutionized Information and Communication Technologies (ICT) network addressing leading to it overriding the inflexible classful network addressing scheme in the nineties by the IETF (Internet Engineering Task Force). The CIDR notation along with the Variable-Length Subnet Masking (VLSM) scheme enable IP routers and filters to cope with arbitrary-length prefixes for networks and subnetworks. In fact, each IP address is comprised of two parts: network/subnetwork prefixes embodied by the most significant bits and an interface/host identifier expressed by the least significant bits. The CIDR notation provides a simple way to identify those parts by specifying the IP address followed by a slash and trailed by a decimal number identifying the routing prefix (i.e., network/subnetwork prefix) of the IP address. Here, the decimal number indicates the number of leading bits that identifies the network/subnetwork. For example, given an IPv4 network (i.e., 32-bit addresses), the notation “192.168.17.0/24” identifies a network prefix corresponding to “192.168.17” and stipulates that the last octet of the IPv4 address is allocated for the identification of network interfaces (i.e., hosts and loT devices). Similarly, given an IPv6 network (i.e., 128-bit addresses), the notation “2001:fb7e::/48” indicates a routing prefix “2001:fb7e:0000” and declares that the remaining 80 bits of the IP address as variables. In the latter case, we must underline a specificity of the IPv6 protocol which statutes that the most significant 64 bits of a global unicast address are for network/subnetwork and the remaining 64 bits are for network interfaces/hosts/devices (see IETF RFC 3587: IPv6 Global Unicast Address Format). Therefore, the 80 variable bits of a global unicast address must be split between 16 bits identifying a subnetwork and 64 bits identifying network interfaces/hosts/devices within the subnetwork.

To optimize the usage of addressing spaces, the Variable Length Subnet Mask (VLSM) technique has been introduced as a design strategy to handle network subnetting. The main idea behind VLSM is to enable the division of an addressing space into a hierarchy of subnetworks with different sizes. Each subnetwork has its own CIDR mask which define its size. The latter is fixed as close as possible to the count of network interfaces in the subnetwork. Thus, the waste of network addresses is limited. As an example, the network addressing space “192.168.1.0/24” consisting of 254 network interface addresses (i.e. 256 addresses minus the network address and the broadcast address) can be divided by the VLSM subnetting strategy into six subnetworks: subnetwork A identified by “192.168.1.0/25” (126 network interface addresses), subnetwork B identified by “192.168.1.128/26” (62 network interface addresses), subnetwork C identified by “192.168.1.192/27” (30 network interface addresses), subnetwork D identified by “192.168.1.224/28” (14 network interface addresses), subnetwork E identified by “192.168.1.240/29” (6 network interface addresses), and subnetwork F identified by “192.168.1.248/29” (6 network interface addresses). In order to use such scheme, a network administrator must use a routing protocol supporting VLSM such as Routing Information Protocol v2 (RIPv2), Open Shortest Path First (OSPF), Intermediate System-to-Intermediate System (IS-IS), Border Gateway Protocol (BGP), or Enhanced Interior Gateway Routing Protocol (EIGRP).

When used in practical use cases such as router IP packet forwarding or firewall IP packet filtering, the CIDR/VLSM addressing scheme is prone to having a high rate of overlapping routing/filtering rules which is the main cause of misconfigurations. When an administrator tries to eliminate all the overlaps between the rules by generating independent ones, he/she is faced with the combinatorial explosion of routing/filtering rules which drop the performance of the routing/filtering device. The latter issue is the main cause of router and firewall misconfiguration. What is needed is to find a new addressing scheme that reduces drastically the number of rules and eliminates the overlapping ones. By doing so, the configuration of network and security devices will be less cumbersome and prone to anomalies (i.e. misconfigurations). Consequently, such new addressing scheme must be backward compatible with the CIDR/VLSM addressing scheme and propose several transitional methods.

Hereafter, related literature is discussed. Patent US20070136557A1 introduces an information processing apparatus for translating IP address and a program product of the information processing apparatus, consisting of a storage means and a processing means. The apparatus stores translation information associating, one-to-one, a value that can be taken by data in a block of a translation object address, with its post-translation value. Indeed, an address translation unit reads a post-translation value associated with a value indicated by data of each block defined in the translation object IP address. Evidently, the techniques described in this patent are not related to any technique presented in the disclosed method.

Patents US20110191493A1 and U.S. Pat. No. 9,392,029B2 disclose an interworking system between IP networks using different IP address format, an application layer gateway (ALG) server, a network address translator, an interworking method, and a message routing method implementing a Session Initiation Protocol. Here the focus is on solving the NAT-traversal problem for interworking between the networks using different IP address formats. Manifestly, all proposed techniques are not connected to the concerns addressed by the present disclosure.

U.S. Pat. No. 7,206,312B2 presents a network address conversion system for accessing a node in a private network. The latter has a private IP address, the computer readable medium encoded with a computer program for executing on a computer, and a recording medium for recording the method. Yet again, there is no direct connection between the proposed techniques and the present disclosure.

U.S. Pat. No. 10,608,987B2 showcases a method for IP address translation services in heterogenous IPv4/IPv6 networks. The method focuses on receiving, at a network node, a data packet from a wireless device. The network node translates the target IP address into a synthetic IP address containing the target IP address. A modified data packet is generated by replacing the target IP address in the data packet with the synthetic IP address. The network node transmits the modified data packet to the destination device. Noticeably, there is no overlap between the techniques of this patent and those disclosed by the present disclosure. Patent CN107508929A discloses a kind of method and device for configuring IP addresses that is not related to the techniques described in this invention.

Patent FR3011705B1 introduces a double-mask notation for IP address Filtering and a method for transcribing filtering policies as single masked IP filters. The IP filter comprises a first mask, adapted to express a first set of authorized IP addresses, a second mask, adapted to express a second set of IP addresses to be excluded from the first set of authorized IP addresses. This invention does not address the problem of overlapping filtering rules as efficiently and as globally as the present disclosure. Several comparative examples with this particular reference are given to show its limitations. So far, with the relative exception of the latter, all the above related patents do not solve the main arisen concern of reducing the number of rules and eliminating the overlapping ones in network and security devices.

Additionally, several research articles have introduced several addressing schemes. For instance, research article doi:10.1016/j.comnet.2021.108700 showcases an addressing scheme called Flexible IP (FlexIP). It is a variable length/hierarchical IP addressing scheme which handles different lengths of addresses in contrast to the fixed length addressing scheme of IPv4/IPv6 and MAC addresses. The authors propose an algorithm called OBF (One Bloom Filter) which acts as an address matching/lookup/routing technique. The authors claim that their technique proactively “adapt/cover various network cases/futuristic unknown scenarios”. However, there is no extensive proof for that claim. In parallel, the authors demonstrate that the OBF is not sensitive to the length of IP addresses, scalable, and efficient (IP lookup speed is almost constant when the routing table increases). Yet, the authors do not address the IP packet filtering problem with respect to firewalls/router rules as addressed by present disclosure. By doing so, the proposed addressing scheme does not handle the issue of overlapping filtering rules. Moreover, while the authors claim that they maintain global reachability with IPv6, they do not demonstrate how their technique is interoperable with the CIDR/VLSM addressing scheme.

Alternatively, research article doi:10.1109/INFOCOMWKSHPS50562.2020.9162703 proposes a hierarchical network architecture where networks “can extend without limitation”. The authors validate the proposed architecture with several techniques. First, an addressing scheme is derived. In this scheme, addresses expose the hierarchical levels of networks and have unbounded limit. Then, the authors handle subnetting by varying the length of addresses through the network structure in a hierarchical manner. Finally, the authors propose a “flexible” packet forwarding technique. Yet again, this paper does not address the IP packet filtering problem when coping with rules handled by network/security devices. Therefore, the issue of overlapping rules is not solved. Furthermore, the authors claim that the current addressing schemes suffer from the problems of address exhaustion, low flexibility, and low packet space efficiency. First, IPv6 address space is 128-bits (2¹²⁸) in size, containing 340,282,366,920,938,463,463,374,607,431,768,211,456 IPv6 addresses (to put this into perspective, it represents roughly 4.25ₓ10²⁸ addresses for each human today (approximately 8 billion people) and nearly 2⁵² addresses for every observable star in the known universe). Second, the CIDR/VLSM techniques offer quite a handful of flexibility to manage the offered address space. By extension, the present disclosure offers more flexibility using the concepts of intervals and sub-intervals. Finally, the 6LoWPAN (acronym of “IPv6 over Low-Power Wireless Personal Area Networks”) protocol offers the possibility to adapt the packet size for constrained networks.

Research article doi:10.1145/3341558.3342204 presents the Flexible Address System (FAS). It proposes an unbounded address space with the possibility to provide variable-length addresses on demand. Correspondingly, multiple Routing Information Bases (RIBs) are proposed to be used on routers to store FAS routing entries according to their different length. With the help of the proposed Multi-EntranceTrie (METrie) data-structure, the RIBs achieve IP packet matching and lookups. Clearly, the authors have not considered the challenging problem of eliminating overlapping filtering rules in network/security devices. Likewise, the authors make the same statement that was discussed above about the previous reference.

The main drawback of the cited addressing schemes is that they have been designed solely to extend the addressing space and therefore do not cope with arisen problematic of significant number of overlapping forwarding/filtering rules in the configuration of network/security devices/software which is the primary cause of misconfigurations. Removing these overlaps generally leads to a combinatorial explosion in the number of configuration rules.

The present disclosure provides a holistically new addressing scheme that copes efficiently with the aforementioned challenge while being totally interoperable with the established CIDR/VLSM scheme. Ultimately, the disclosed invention eliminates the overlapping of configuration rules in network and security devices, while avoiding the exponential growth in rule numbers and greatly enhance the performance, efficiency, and effectiveness of all network and security devices. None of the conventional methods has achieved such accomplishment.

The disclosed invention relates to addressing scheme using an original encoding of disjoint address intervals. The specified notation defines an encoding to allocate IP disjoint address intervals within subnetwork prefixes and network interfaces/hosts/devices identifiers building on the IP general addressing architectures defined in IETF RFC 2101 and IETF RFC 4291 respectively for IPv4 and IPv6.

It is important to note that the disclosed notation extends beyond the IPv4/IPv6 addressing architectures to any addressing architecture handling a certain number of addressing groups disjointed by a separator and composed of a certain number of bits encoded in a particular number basis. The disclosed invention covers all the potential uses of the disclosed addressing scheme in any addressing architecture.

A difference between CIDR/VLSM notation and Bouhoula-Kaâniche Addressing Scheme (BKAS) notation is the usage of a disjoint address interval encoding applicable to any of the addressing group instead of a single network prefix mask applicable to the whole IP address. The great potential and expressiveness of the disclosed notation is shown by highlighting its usage within several ICT networking and cybersecurity applications. An emphasis has been put to underline the breaking edge between the two notations while still preserving the backward compatibility of BKAS with CIDR/VLSM.

It is an object of this invention to define a new standard for addressing architectures to enhance the experience of network and cybersecurity engineers when dealing with the configurations of network/cybersecurity devices/software.

### SUMMARY OF THE INVENTION

The disclosed invention concerns a novel general-purpose IP addressing scheme called Bouhoula-Kaâniche Addressing Scheme (BKAS). In conformance with the joined embodiments, an IP addressing scheme using an original disjoint address interval encoding enables several disjoint addressing intervals with a single concise and complete notation. With the usage of this new notation, an IP packet matching mechanism is specified in terms of logical circuit and concrete software implementation. Moreover, three transitional methods are provided: (1) a method for converting from classical CIDR/VSLM notation to BKAS notation, (2) a method to decode from BKAS notation all the encoded addressing intervals, (3) a method for combining between BKAS notations encoding for consecutive disjoint intervals. Consecutively, the great potential and expressiveness of the addressing scheme is showcased throughout its usage in challenging ICT networking or cybersecurity applications such as IP routing or IP filtering when handling rules associated with binary actions (e.g., accept/deny, forward/drop), with ternary actions (e.g., accept/reject/forward), or with multiple actions (e.g., forward, drop, set, queue, go). In each of the latter scenarios, the BKAS notation enables the reduction of the number of handled rules dramatically by combining all contiguous/disjoint ones and eliminating all overlapping ones. Afterwards, a method for implementing security policies with the usage of BKAS notation is described to underline the expressiveness and effectiveness of the disclosed addressing scheme.

In contrast with the established industrial IP addressing scheme, the BKAS notation can be applied to different addressing groups of an IP address. The disclosed notation and the packet matching mechanism can be summarized in five steps. First, each IP address is split into addressing groups (e.g., four groups of eight bits for IPv4 and eight groups of sixteen bits for IPv6). Second, each addressing group can be affected by interval encoding and becomes an interval encoded addressing group. Third, each bit of each specified addressing group accounts for an inclusion/exclusion decision concerning an associated interval of the addressing group. All encoded intervals are disjoint, and their union is equal to the whole possible interval (i.e., forming a partition of the specified address group or of the designated subgroup). Fourth, each interval encoded addressing group is confronted with the corresponding addressing group in the actual IP address which casts a decision vote. Finally, the packet matching mechanism resolves all votes and combines them to make its final matching decision.

When used within an IP networking or cybersecurity application, the BKAS notation can be adapted to tackle the considered problem more efficiently and more effectively than the established industrial standard addressing scheme. More precisely, the disclosed invention will simplify noticeably the configuration tasks of system administrators with respect to network architecture complexity and security policies intricacies. Indeed, managing rules in ICT networking or cybersecurity applications such as IP routing or IP filtering has become such a complex and error prone task that the margin of errors is very high even if the system administrator is an expert. Also, emphasis should be put on improving routing/filtering performance specially for high-speed networking where a huge number of packets are confronted every second with a plethora of routing/filtering rules. By reducing the number of handled rules and eliminating potential overlaps between them, the BKAS notation tackles efficiently and effectively the arisen problems while guaranteeing that the translation of these rules from security policies is as simple as possible. Thus, it is easier and more straightforward to update and to rearrange the filtering rules by prioritizing the most solicited ones since they are independent and strongly coupled with the security policies. Moreover, the latter properties greatly simplify the process of rule optimization. While using a classical CIDR/VSLM notation, the removal of the overlaps between the filtering rules implies a combinatorial explosion of their number. The disclosed invention avoids particularly this specific problem.

The BKAS notation has been designed to be a general-purpose addressing scheme thanks to the usage of an original address disjoint interval encoding. It has the potential to be applicable to any network devices (e.g. routers, switches) or/and any cybersecurity devices (e.g. firewalls) and to handle any kind of rules with any kind of binary actions (e.g., accept/deny, forward/drop), ternary actions (e.g., accept/reject/forward), or multiple actions (e.g., forward, drop, set, queue, go).

Beyond the detailed technique, the present invention covers all techniques that are based on any disjoint interval encoding technique used for an addressing scheme. Several alternative notations using different disjoint interval encodings as well as several extensions are disclosed as a proof of the versatility of the interval encoding strategy for coming up with multitude addressing schemes. The discussed techniques are given extensively and not exhaustively. All these extensions and alternatives should be known as versions and subversions of the BKAS notation. Any apparatus or a device using any of the aforesaid methods is also covered.

### BRIEF DESCRIPTION OF THE DRAWINGS

For a more complete understanding of the invention, reference is made to the following description and accompanying drawings, in which:

FIG. 1 illustrates five examples of performing the BKAS addressing scheme: 105 shows two examples with the IPv4 addressing architecture, 106 describes two examples with the IPv6 addressing architecture and 107 depicts an example with the IEEE 802 MAC addressing architecture;

FIG. 2 showcases the ABNF specification for BKAS notation;

FIG. 3 is an exemplary embodiment for a reference Logical Circuit Implementation of the IP packet matching mechanism for a single addressing group of 3 bits;

FIG. 4 is a flowchart for a software implementation of the IP packet matching method;

FIG. 5 is a logic circuit-based use case for IP address 111 and interval encoded group 100;

FIG. 6 is a logic circuit-based use case for IP address 001 and interval encoded group 111;

FIG. 7 is a logic circuit-based use case for IP address 101 and interval encoded group 011;

FIG. 8 shows some IP Routing (forward/drop) and Filtering (deny/accept) Rules with CIDR/VLSM notation;

FIG. 9 illustrates the IP Routing/Filtering overlapped rules with double mask notation;

FIG. 10 demonstrates the IP Routing/Filtering Rules with Double mask notation without overlapping;

FIG. 11 lists a set of IP filtering rules using CIDR notation;

FIG. 12 enumerates a set of IP routing rules using CIDR notation;

FIG. 13 showcases an example network architecture for VLSM subnetting;

FIG. 14 represents two sample directives from a set of security policies;

FIG. 15 is a list of examples of BKAS/ASLDIE alternative notation;

FIG. 16 is a drawing of a sample directive from sample security policies to be implemented in BKAS/ASLDIE notation;

FIG. 17 is an illustration of network and security devices which can be impacted with significant enhancements by applying the disclosed techniques;

FIG. 18 is an illustration of a computer system having processing circuitry and program instructions for performing disclosed methods;

FIG. 19 is a flowchart for a method of encoding disjoint address intervals by a Bouhoula-Kaâniche Addressing Scheme (BKAS);

FIG. 20 is a flowchart for a method of combining consecutive BKAS notations;

FIG. 21 is a flowchart for a method of converting a CIDR/VLSM encoded address into BKAS encoded addressing groups;

FIG. 22 is a flowchart for a method of decoding, in BKAS encoded addressing groups, encoded addressing intervals with associated actions;

FIG. 23 is a flowchart for a method of translating a security policy into the BKAS encoded addressing groups; and

FIG. 24 is a flowchart for a method of performing a coherence check of an action bit mask.

### DETAILED DESCRIPTION OF THE PREFERRED EMBODIMENTS

Henceforth, formal definitions of the novel BKAS addressing scheme and the associated IP packet matching mechanism are specified. Also, several related methods ensuring the backward compatibility with the classical CIDR/VLSM notation, and the precise implementation of security policies are identified.

The Bouhoula-Kaâniche Addressing Scheme (BKAS) notation consists of an IP address split in addressing groups (e.g., four groups of eight bits for IPv4 and eight groups of sixteen bits for IPv6) detached by a separator (e.g., a dot “.” for IPv4 and a column “:” or a double column “::” for IPv6). Each addressing group may be specified by either a literal specification (e.g., a decimal integer for IPv4 and a hexadecimal integer for IPv6) representing a fixed value for its bits or an interval encoded addressing group composed by a literal specification (decimal for IPv4 and hexadecimal for IPv6) followed by a vertical bar “|” and trailed by a selector number comprised between zero and eight for IPv4 and between zero and sixteen for IPv6 (i.e., between zero and the number of bits used for an addressing group). By definition “a|0” (simply noted as “a”) means that the only possible value for the addressing group is the fixed value “a” (i.e. there is no “interval encoding part”).

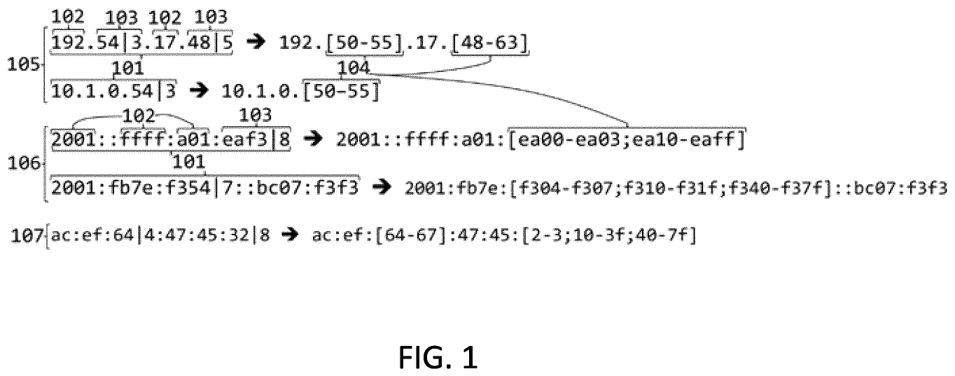

FIG. 1 showcases five valid examples of performing the BKAS notation scheme: two IPv4 addressing architecture examples [105], two IPv6 addressing architecture examples [106], and an IEEE 802 MAC addressing architecture example [107]. Whatever the chosen addressing architecture is, The BKAS notation scheme splits an Address [101] into several addressing groups which can be Literal Specified Addressing Group [102] or Interval Encoded Addressing Group [103]. Also, Matched Intervals of an Interval Encoded Addressing Group [104] are illustrated. Here the vertical bar is used as a default separator to distinguish the BKAS notation from the established CIDR notation which uses the slash symbol as a separator.

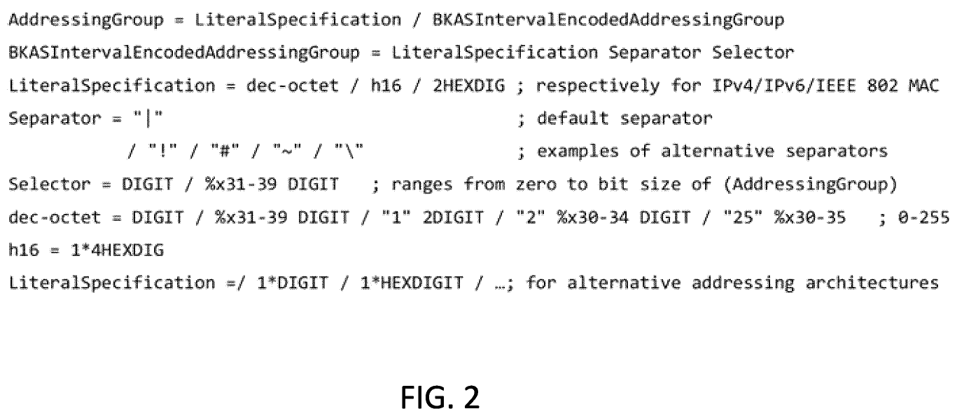

In an embodiment, a BKAS notation scheme uses an encoding mechanism. Given the Augmented Backus-Naur Form (ABNF) for IPv6/IPv4 literals as corrected by IETF RFC 5954 and the ABNF for IEEE 802 MAC literals as “MACaddress=2HEXDIG “:” 2HEXDIG “:” 2HEXDIG “:” 2HEXDIG “:” 2HEXDIG “:” 2HEXDIG”, the ABNF for the BKAS notation can be encoded by an encoding mechanism by identifying an addressing group in each of them and stipulatingthat “BKASIntervalEncodedAddressingGroup=AddressingGroup “|” 1*2DIGIT; the number after the separator ranges from 0 to the bit size of the addressing group”. FIG. 2 defines the reference ABNF for the BKAS Notation. Note that the BKAS notation scheme can be applied to any addressing architecture based on the usage of addressing groups. For the sake of clarity, the focus is exclusively on IPv4/IPv6 addressing architecture in the remainder of this specification.

An interval encoded addressing group is defined according to the following established axioms: Let “a” be a number expressed in any basis (e.g., decimal for IPv4, hexadecimal for IPv6) belongingto the interval [0,2ⁿ_1] where n is the number of bits of the addressing group (e.g., 8 for IPv4 and 16 for IPv6), “bₙ₋₁ bₙ₋₂ . . . b₁b₀” is the binary representation of “a”, let k∈[0,n]. The encoding mechanism can encode the interval encoded addressing group “alk” by dividing into two parts: the most significant bits “bₙ₋₁ bₙ₋₂ . . . bₖ” considered as a fixed value (inexistent when k is equal to n) and the least significant bits “bₖ₋₁ . . . b₂b₁b₀” interpreted as an interval encoding (non-existent when k is equal to 0). Each bit from the interval encoded part indicates whether a corresponding address interval is to be matched (the bit is set) or to be mismatched (the bit is unset). The address interval associated with a bit “bᵢ” (i∈]0, k−1]) within the interval encoded part is]2ⁱ_1,2ⁱ⁺¹_1] and for i=0 the encoded interval is [0,1] (i.e. [2⁰−1,2¹−1]). As shown later, every CIDR/VLSM notation can be translated, by processing circuitry, to its semantically equivalent BKAS notation.

In the following, an insightful example of a resolution mechanism that showcases an advantage of the disclosed invention. The BKAS notation “192.84|8.17.204|8” uses two interval encoded groups: one for the 2nd addressing group and another one for the 4th addressing group. The resolving, by the resolution mechanism, of the BKAS notation is performed in two steps. First, the leftmost interval encoded group is resolved to identify the intervals of matched subnetworks. Thus, only IP addresses with routing prefixes “192.[4-7]0.17”, “192.[16-31]0.17”, and “192.[64-127]0.17” are matched by the BKAS notation scheme. If the routing prefix of an IP address conforms to the latter intervals, the second interval encoded group is then resolved. The latter will only match IP addresses having their least significant address group in the ranges [4-15] and [64-255] within the already validated routing prefix.

The aforementioned resolution technique is considered as the default resolution technique for BKAS notation in which a zero encodes for a mismatched interval and a one encodes for a matched interval. However, one can derive alternative resolution techniques by modifying the way the resolution between multiple interval-encoded-groups is performed, by switching the encoding for interval matching/mismatching. All alternative resolution techniques are assumed to be covered by the disclosed invention.

According to the BKAS notation, several IP matching mechanisms can be defined. The disclosed invention covers all the variants of matching mechanisms exploiting the BKAS notation. As a proof of concept, a straightforward and default IP matching mechanism is hereafter detailed.

A default IP filtering resolution mechanism performs in three steps:
First, for each addressing group (having a binary representation “bₙ₋₁ bₙ₋₂ . . . b₁ b₀”) of an actual IP address associated with an interval encoded addressing group (e.g., having a binary representation “fₙ₋₁ . . . fₖ iₖ₋₁ . . . i₀”) from a BKAS notation (“f” for fixed bits and “i” for interval encoding bits) do:
   Iterate over the interval encoding bits of the interval encoded addressing group from the least significant bit to the most significant bit (i.e., i₀ . . . iₖ₋₁):
      If a bit “bₘ” in the actual IP address is set (i.e., having a value of one) while the corresponding interval encoding bit is unset (i.e., having a value of zero), cast a vote for packet mismatching if and only if for all iₛ∈[iₘ₊₁ . . . iₖ₋₁], if iₛ=1 then bₛ is unset. In other terms, cast a vote for packet mismatching if and only if, in the actual IP address, all more significant bits other than an actual mismatched bit, associated with set interval encoding bits, are unset. This step encompasses the intuitive observation that numbers from high order intervals have a binary representation that includes within it the binary representation of low order intervals. For example, the binary representation of the decimal number 212 is 11010100 which includes the binary representation of the decimal number 20 (i.e., 10100) which in turn includes the binary representation of the decimal number 4 (i.e., 100). So, given the interval encoded addressing group “21218”, the actual IP addressing groups 117 (i.e., 1110101), 28 (i.e., 11100) and 7 (i.e., 111) are matched whereas the actual IP addressing groups 52 (i.e., 110100), 12 (i.e., 1100), and 3 (i.e., 11) are mismatched.
   Iterate over the fixed literal bits of the interval encoded addressing group from the least significant bit to the most significant bit (i.e., fₖ . . . fₙ₋₁):
      If any bit in the actual IP address is different from its corresponding fixed literal bit, cast a vote for packet mismatch.
   If the previous checks have not casted a vote for mismatch, cast a vote for a match.
Second, for an addressing group not associated with an interval encoded addressing group, a default IP matching mechanism must declare the packet as mismatched if and only if the addressing group in the actual IP address is not equal to the equivalent addressing group in the BKAS notation.
Finally, if any resolution of any addressing group casted a vote for mismatching, then the packet should be declared mismatched by a default IP matching mechanism.

Since the BKAS notation introduces the possibility to apply multiple intervals encoding to different addressing group in an IP address, it has the potential to extend the classical interpretation of address resolution with new unexplored criteria. While the default matching mechanism casts a mismatch when any of the addressing groups is casting a mismatch (i.e., the classical resolution), it is important to note that various IP matching mechanisms can be derived from the default IP matching mechanism described above.

For example, one can choose to change the final step by declaring a packet as mismatched if and only if any of the addressing groups not associated with an interval encoded addressing group vote for mismatch and all the addressing groups associated with an interval encoded addressing group vote for mismatch.

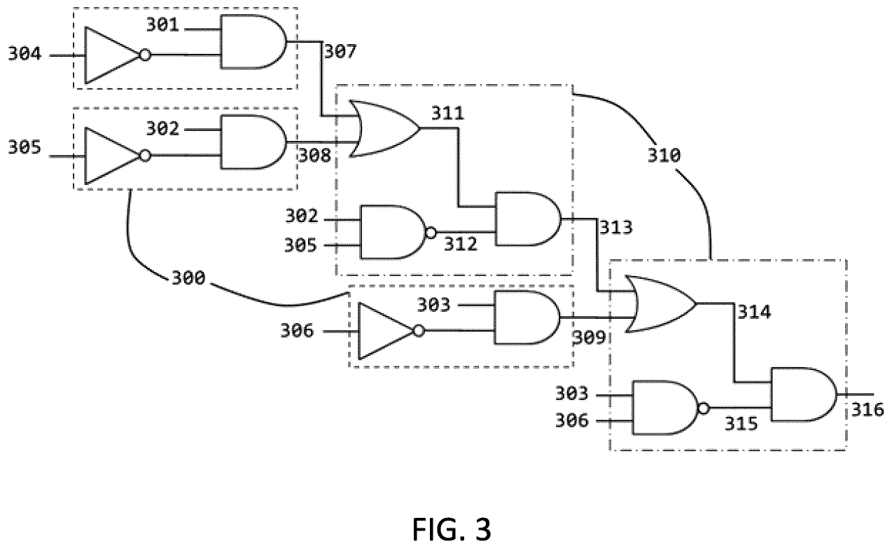

Another one can choose to change the final step by declaring packet as mismatched if and only if any of the addressing groups not associated with an interval encoded addressing group vote for mismatch and if the chaining of the votes of all addressing groups associated with an interval encoded addressing group by the mean of several chaining logical circuits (see FIG. 3, [310]) vote for mismatch.

The interpretation of these matching mechanisms can be adapted for several challenging use cases in IP routing and IP filtering. The two mentioned alternative matching mechanisms are given as examples. Quite simply, for any IP packet matching mechanism combined in any logical manner results from the matching of a single addressing block according to BKAS notation is covered by the disclosed invention. Moreover, any hardware or software implementation conforming or logically equivalent or is a semantical extension to/of the logical circuits for single addressing group filtering as presented by FIG. 1 is covered by the disclosed invention.

FIG. 3 presents a logical circuit implementation of a default IP packet matching mechanism for a single addressing block of 3 bits. The actual IP address corresponds to the bits [301], [302] and [303] (the least significant bit is [301] and the most significant bit is [303]. The BKAS notation associated interval encoded addressing group is formed by the bits [304], [305] and [306] (the least significant bit is [304] and the most significant bit is [306]).

For an addressing block of 3 bits, three Mismatching Logical Circuits [300] and two Chaining Logical Circuits [310] are needed to perform the matching process. The Mismatching Logical Circuit [300] evaluates if the bit in the IP address mismatches the corresponding bit in the interval encoded addressing group according to BKAS notation. If the interval encoded addressing group bit is set, the mismatching logical circuit outputs zero (i.e., no mismatch) (the value of the bit in the actual IP address is irrelevant). Otherwise (i.e., the interval encoded addressing group bit is unset), it tests if the bit in the actual IP address is set. If the latter is set then there is a mismatch and the mismatching circuit outputs one (i.e., mismatch). The outputs of the mismatching logical circuits ([307], [308] and [309]) are combined with the chaining logical circuits. For each Chaining Logical Circuit[310], there are four inputs: the output of the previous logical circuit to be chained ([307] and [313]), the output of the current mismatching logical circuit ([308] and [309]), the current bit to be chained from the actual IP address ([302] and [303]), and the current bit to be chained from the interval encoded addressing group ([305] and [306]).

The overall chained mismatching results ([311] and [314]) are evaluated by an “or gate”. If the current bits to be chained from the actual IP address and the interval encoded addressing group ([312] and [315]) are both set, the chaining circuit overrules the overall mismatching results from the previously chained bits. Otherwise, the latter is sustained. The output of the chaining logical circuit of the most significant bit indicates the Final Mismatching Decision [316] between the actual IP addressing group and the interval encoded addressing group.

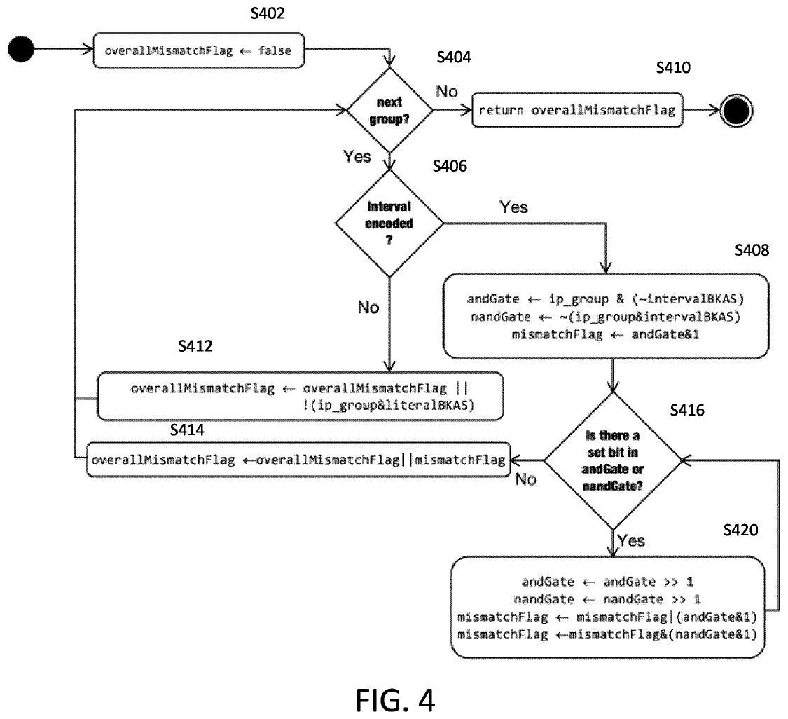

Following this hardware implementation, a reference software implementation for the default resolution technique of BKAS notation using full interval encoded groups (i.e., |8 for IPv4 and |16 for IPv6) can be easily derived as in the flowchart of FIG. 4. In the flowchart, “&” denotes the bitwise AND operator, “˜” denotes the bitwise NOT operator, “>>” the bitwise RIGHT SHIFT operator, “|” denotes the BITWISE OR operator, “∥” denotes the OR operator and “!” denotes the NOT operator. It is important to note that the reference software implementation uses exclusively bitwise and logical operators. Further hardware/software implementations can be derived from the reference hardware/software implementations.

In step S402, a Mismatch Flag is initially set to false. In step S404, it is determined whether there is a next group. When there are no more groups, in step S410, the overall Mismatch Flag will be returned.

For the next group (YES in S406), in step S406, it is determined whether the group encodes an interval.

When the group encodes an interval (YES in S406), in step S408, a mismatch flag is set. In step S416, a decision is made whether there is a set bit in an andGate or a nandGate.

When the group does not encode an interval (NO in S406), in step S412, the overall Mismatch Flag is set accordingly.

When the bit is set in the andGate or the nandGate (YES in S416), in step S420, the mismatch flag is set accordingly.

When the bit is not set (NO in S416), in step S414, the overall Mismatch Flag is set accordingly.

The computational complexity of any software implementation based on the provided hardware implementation is expressed by the equation (1).

$$T ( n ) = Θ ( ns ) = O ( ns ) = Ω ( n ) \qquad ( 1 )$$

where n is the number of addressing groups of the IP address (e.g., 8 for IPv6 and 4 for IPv4) and s is the number of bits in an addressing group of the IP address (e.g., 16 for IPv6 and 8 for IPv4). Here, T(n) denotes the time complexity function. The “Θ” operator accounts for the mean-case complexity, the “o” operator reports the worst-case complexity and the “Ω” operator indicates the best-case complexity. Note that the best case complexity occurs when the whole addressing group is fixed since the matching can be reduced to the equality tests of the bits. Whereas, the worst-case complexity occurs when the whole addressing group is used for interval encoding.

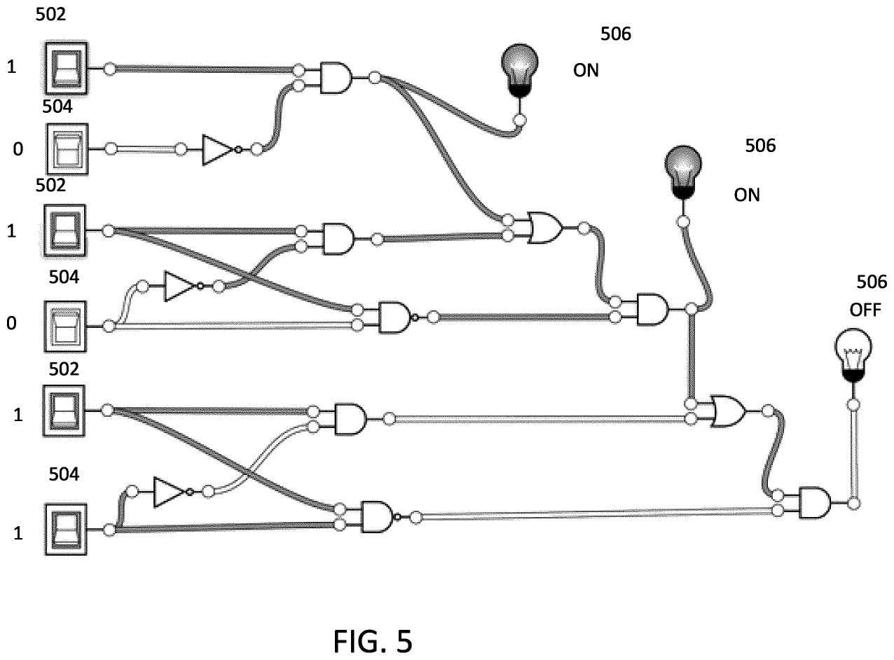

For further understanding of the logical circuit implementation, FIGS. 5, 6, 7 illustrate several use cases of the logic circuit of FIG. 3 have been included with respect to the enclosed embodiments: FIG. 5 illustrates the use case for IP address 111 and interval encoded group 100. Since the first two least significant bits are mismatched, the two first mismatch indicators are on. However, the most significant bit is set and matched. Therefore, the overall address matches, and the last mismatch indicator is off.

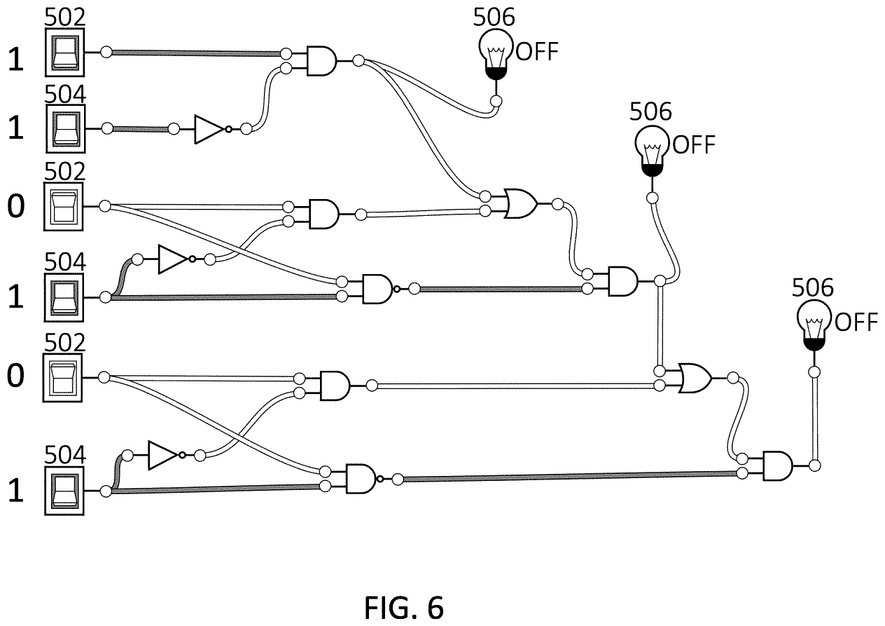

FIG. 6 showcases a use case with an interval encoded group 111 which matches all intervals and so all the mismatch indicators are off.

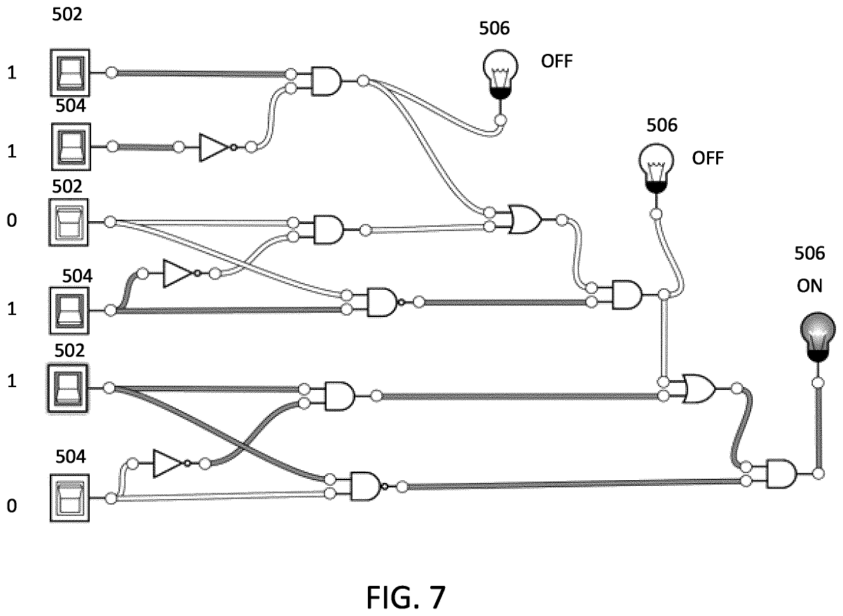

FIG. 7 depicts the use case for IP address 101 and interval encoded group 011. Here the most significant bit is set and mismatched. Consequently, the overall address mismatches and the last mismatch indicator is on.

So far, an addressing scheme using an original disjoint address interval encoding notation called BKAS coupled with an adequate and straightforward IP packet matching mechanism have been described. The remainder of this disclosed invention defines a set of auxiliary methods to ensure the backward compatibility of the invention with the established industrial standard CIDR/VLSM and to ensure its synergic adequacy with the ease of implementation of security policies as lists of filtering rules. The present invention concerns also a method containing a compactor technique and a multiple steps process for converting a CIDR/VSLM notation into a single BKAS notation.

First, a compactor method is hereby defined for combining contiguous interval BKAS notations which are non-overlapping, exclusively matching all intervals (i.e., all bits in any interval encoding part of any interval encoding address group are set), and sharing the same literal addressing groups into a single BKAS notation. For example, the BKAS notation “10.1.0.87|3” and the BKAS notation “10.1.0.95|3” are equivalent to the following single BKAS notation “10.1.0.95|4”. The general combination technique for a particular interval encoded addressing group consists of the following steps:
Sort all related, non-overlapping addresses, exclusively matching all intervals, and having consecutive (i.e., contiguous) BKAS notations in increasing order of their interval covering.
Let the overall interval equal to [start, end] where “start” must be the start of the first interval in the sorted set and “end” must be the end of the last interval in the sorted set.
Compute the number of bits needed for interval encoding which is equal to log₂(len+1) where “len” is the length of the overall interval.
The single BKAS notation equivalent to the provided set of BKAS notations for this interval encoded addressing group is “end|(log₂(len+1))”.

Second, a method for converting from a single CIDR/VSLM notation to a single BKAS notation is encompassed by the following steps:
Base case for IPv4 addresses
   Let a.b.c.d/n be a CIDR/VSLM IPv4 address where n≥24 and let k=n mod 8.
   Let “b₈, . . . , bₖ, bₖ₋₁, . . . , b₀” be the binary representation of “d”.
   Let _{d}′ be the decimal number which binary representation is “b₈, . . . , bₖ,1, . . . , 1”.
   The equivalent BKAS notation of a.b.c.d/n is a.b.c.d′|(8−k).
Base case for IPv6 addresses
   Let a:b:c:d:e:f:g:h/n be a CIDR/VLSM IPv6 address where n≥112 and let k=n mod 16
   Let “b₁₆, . . . , bₖ, bₖ₋₁, . . . , b₀” be the binary representation of h.
   Let h′ be the hexadecimal number which binary representation is “b₁₆, . . . , bₖ1, . . . , 1”.
   The equivalent BKAS notation of a:b:c:d:e:f:g:h/n is a:b:c:d:e:f:g:h′|(16−k).
General cases for IPv4/IPv6 addresses for n<24 in IPv4 or n<112 in IPv6 Let m be the result of “(32−n) div 8” for IPv4 and of “(128−n) div 16” for IPv6. All the m rightmost addressing groups are assigned to the interval encoding group “25518” for IPv4 and “FFFF|16” for IPv6. The (m+1)^{th} rightmost addressing group is treated as if it was a base case for the corresponding used protocol by disregarding the condition on n and computing k as follows: k=n mod 8 for IPv4 and k=n mod 16 for IPv6.

The following two examples illustrate how the conversion is performed by the aforementioned method: (1) Consider 10.1.0.80/29, here n>24 so the base case is applied: k=29−24=5. Since the binary representation of 80 is 01010000 and by conserving the 5 most significant bits and setting the 3 least significant bits, the corresponding BKAS notation is “10.1.0.87|3”. Method (2) Consider 10.1.80.0/21, here n<24 so this is a general case: b=(32−21) div 8=3 and k=21 mod 8=5. So, the corresponding BKAS notation is “10.1.87|3.255|8”.

Here it is important to note that any BKAS notation generated by the previous method is exclusively matching all encoded intervals. So, a set of BKAS notations generated from a set of CIDR/VLSM notations by the second method can be rearranged accordingly in subsets and, whenever it is possible, a subset is fed as input to the first method to compact its BKAS notations.

Third, a method to decode from BKAS notation all the encoded addressing intervals is herewith described. Note that the decoding of an interval encoded addressing group according to BKAS notation into IP address intervals is straightforward and derives immediately from the formal definition of the notation. For instance, a simple technique is to apply the following algorithm: For each set bit “k” in the interval encoded addressing group, output the interval]2^{k}−1,2^{k+1}−1] as a matching interval. Note that if k=0 then the left side of the interval is included.

In this context, a general technique for converting a set of related overlapping CIDR/VLSM notations to a single BKAS notation is derived:
Sort all the CIDR/VLSM based notations and convert them into address intervals.
If all the intervals are in the form]2^{p}−1,2^{q}−1] where p<q, then all the CIDR/VLSM based notations translate into a single BKAS notation.
Otherwise, group them by subsets of consecutive (i.e., contiguous) CIDR/VLSM based notations. For each subset, if the condition in the previous step holds then translate its CIDR/VLSM based notations into a single BKAS notation. Otherwise, try to find a common prefix between the CIDR/VLSM based notations of the subset to translate them to a single BKAS notation. Otherwise, try to recursively find common sub-prefixes. Each group of CIDR/VLSM based notations sharing the same sub-prefixes can be translated to a single BKAS notation.
For all remaining non-treated CIDR/VLSM based notations, apply for each of them the second proposed method (see paragraph 0051) for a single CIDR/VLSM notation translation into BKAS notation.

For example, the following CIDR/VLSM notations (10.1.0.0/30, mismatch), (10.1.0.4/30, match), (10.1.0.8/29, mismatch), (10.1.0.16/28, mismatch), (10.1.0.32/27, match), (10.1.0.64/26, mismatch), and (10.1.0.128/25, mismatch) are equivalent to the unique BKAS notation 10.1.0.3618 considering that 36 is the binary representation of 00100100.

Similarly, the subsequent CIDR/VLSM notations (10.1.0.0/30, match), (10.1.0.4/30, match), (10.1.0.8/29, mismatch), (10.1.0.16/28, match), (10.1.0.32/27, match), (10.1.0.64/26, mismatch), and (10.1.0.128/25, match) are expressed by the unique BKAS notation 10.1.0.18318 since 183 is the binary representation of 10110111.

Alternatively, the VLSM design strategy for network subnetting can be adapted to use the BKAS notation directly.
First, a system administrator has to sort all planned subnetworks by their size in a descending order and by considering for each subnetwork the host addresses, broadcast addresses and network addresses.
Second, assign each subnetwork to the appropriate intervals of a BKAS interval encoded addressing group.
Third, when applicable, use either multiple BKAS interval encoded addressing groups as discussed previously or use the Subintervals Encoding (BKAS/SE) extensions as discussed later to handle macrosubnetworks or sub-subnetworks respectively.
Finally, use the resulting BKAS notations for routing/filtering purposes by using any of the techniques showcased in the remaining section. It is important to note that the VLSM design strategy is embodied implicitly when using the BKAS notation with the advantage to associate additional information about IP packet routing/filtering rules as described in the remaining of this section.
   The implementation of this strategy by the network administrator enables the removal of all overlaps in the configuration rules of network and security devices, while avoiding combinatorial explosion of the number of configuration rules.

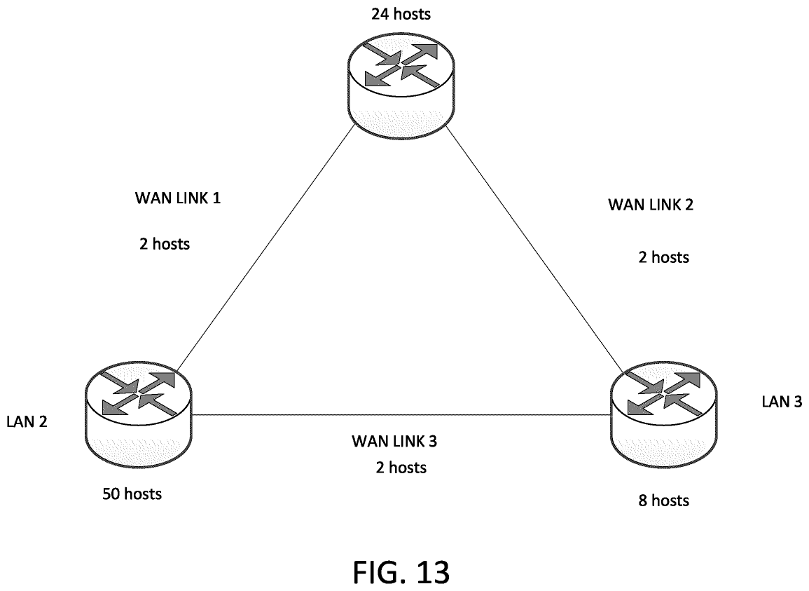

As an example, the network architecture showcased by FIG. 13 when associated with the addressing space “192.168.2.255|8” gives the following subnetworks: Lan2 “192.168.2.128|7”, Lan1 “192.168.2.64|6”, Lan3 “192.168.2.32|5”, WAN link 1 “192.168.2.16|4”, WAN link 3 “192.168.2.8|3” and WAN link 2 “192.168.2.4|2”.

Taken together, the previously defined methods cooperate to ensure the backward compatibility, conciseness, and the clarity of interpretation of the BKAS notation.

At this stage, the BKAS notation has been defined and its backward compatibility with CIDR/VLSM has been exhibited. Advantages of the BKAS notation over the established standard industrial addressing scheme are: (1) its usage of a disjoint address interval encoding and (2) the applicability of the latter encoding to any IP addressing group.

Now, the great potential and expressiveness of the BKAS notation is unleashed by demonstrating its practical usage advantages when coupled with an ICT networking or cybersecurity application which handle any kind of IP networking/cybersecurity rules. It is important to note that throughout the remaining of this invention disclosure, for the sake of clarity and without loss of generality, protocols, ports, and dual source/destination addresses and further attributes in rules definition are discarded. Only a single IP address as a single attribute with the associated implicit or explicit actions are used to illustrate all IP Routing/Filtering rules in all the examples. In the same spirit, binary actions are discussed first, then ternary actions and finally multiple actions are disclosed.

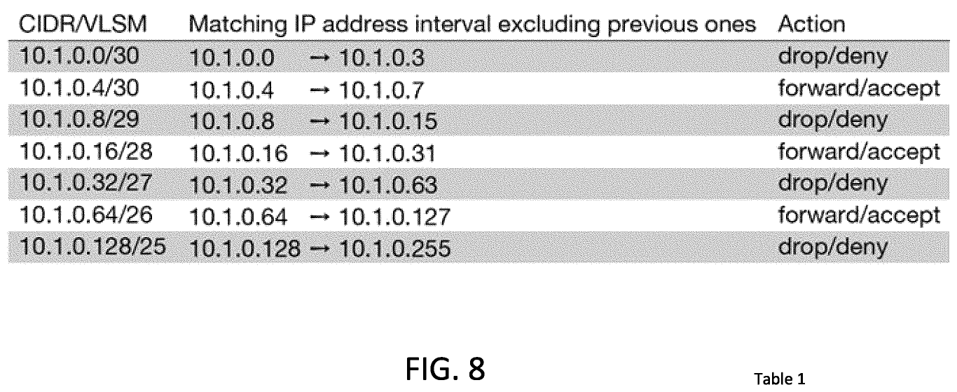

According to the CIDR/VLSM notation, several mechanisms for IP packet filtering have been proposed. For instance, patent #US20020143787A1 introduced a method and apparatus for longest match search of routing tables. More recently, patent #FR3011705B1 defines a double mask IP filter. However, each of these techniques must deal with a plethora of rules due to limitations inherent to the CIDR/VLSM notation and the complexity of security policies. Some of the rules overlap over the IP address intervals to handle exceptions. Subsequently, the rules must be ordered and applied in the specified order by IP filters to conform to security policies. Tables 1, 2 and 3 in FIGS. 8, 9, and 10 illustrate the arisen concern. Considering the following set of IP Routing/Filtering rules using CIDR/VLSM notation:

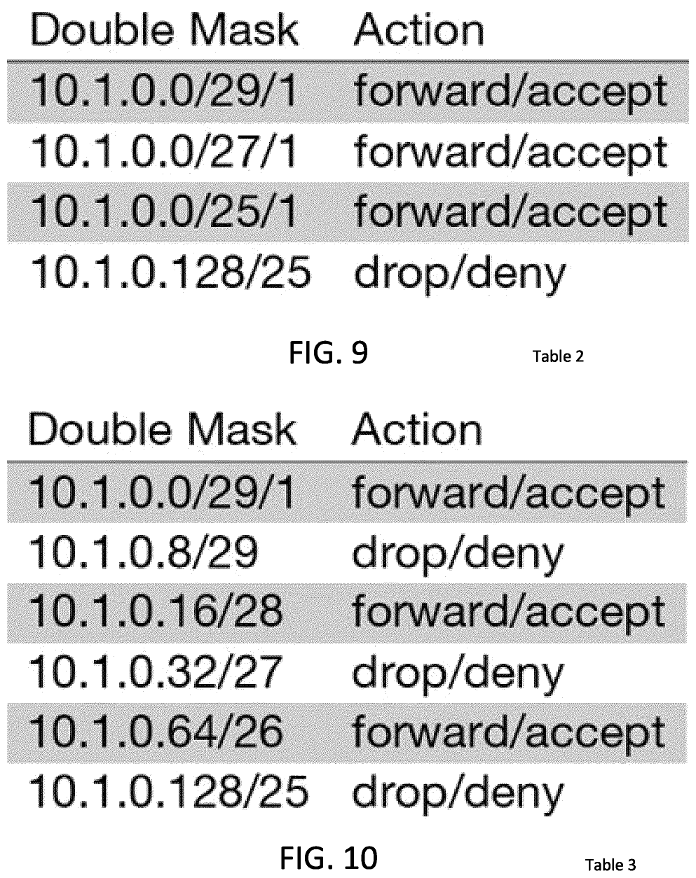

Under the assumptions of the patent #FR3011705B1, four rules with overlaps between the first 3 rules must be derived and therefore they must be adopted as is in the same unique order by any IP Router/Filter (see Table 2 in FIG. 9). Alternatively, when overlapping rules are to be avoided, six non-overlapping rules can be deduced (see Table 3 in FIG. 10).

So far, one can argue that there are infinite situations in which there are rules with very intricate overlaps in IP address intervals due to specific security policies. Often, system administrators complain about the huge amount of work and attention needed to maintain such set of filtering rules. Indeed, paying attention to the overlap between rules and their order is a tedious task. The huge number of misconfigurations (i.e., syntax anomalies such as redundancy, generalization, correlation, shadowing, . . . ) and conflicts with security policies is an undeniable proof of the latter observation. This is even considered as a critical issue due to the huge never-ending increase in the number of packets treated by IP filters and the ever-increasing number of rules. Therefore, several costly tools have been proposed to detect and eventually correct (depending on the availability of the feature in the tool) these misconfigurations and conflicts.

An objective is to represent each group of overlapping rules (i.e., sharing wholly/partly the same domain of addresses under CIDR/VLSM notation) as one single concise and effective rule expressed by the BKAS notation. The idea feature that makes BKAS notation even more expressive than CIDR/VLSM notation is that while the latter only represents the structure of the address domain, the former can encode a binary action (e.g., forward/drop, accept/deny) within the interval encoding by overriding the match/mismatch binary actions. By doing so, the BKAS notation unleashes horizons of possibilities and expressiveness for IP packet routing and filtering. In an embodiment, an adaptation mechanism can adapt the associated IP packet matching mechanism in the same manner by overriding the match/mismatch binary actions with the adequate routing/filtering binary actions. The resultant IP routing/filtering mechanism is overall more efficient and more effective than classical ones thanks to the dramatically reduced number of rules by the BKAS notation. Likewise, the derived rules from the BKAS notation can be deduced immediately from security policies. Thus, it reduces considerably any anomalies and renders obsolete all the overpriced tools tackling their detection and correction. According to this interpretation, the sole statement of a BKAS notation can be equivalent to a set of rules. For instance, the rules showcased by Table 1 in FIG. 8 can be translated to the BKAS notation “10.1.0.84|8” in which the binary actions are implicitly encoded into the notation (all matched intervals are associated with the first action and all mismatched intervals are associated with the second action). Henceforward a detailed explanation of how the latter notation is equivalent to the rules shown in Table 1 in FIG. 8 is as follows:

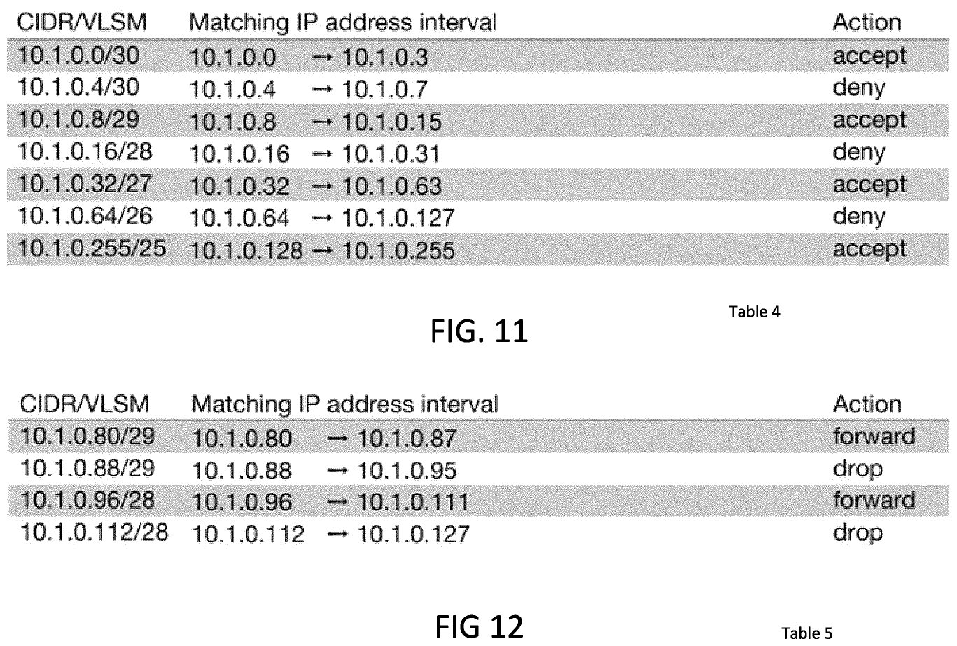

The binary representation of the decimal number 84 is 01010100. The least significant bit is unset and thus it indicates that the addresses in the range [0,1](i.e., [2⁰−1,2⁰⁺¹−1]) are to be rejected. Next, the second bit is also unset and so specifies that the addresses in the range]1,3] (i.e.,]2¹−1,2¹⁺¹−1]) are to be rejected. Combining the information from the two first bits, it follows that all addresses in interval [0,3] and prefixed with “10.1.0.” are to be rejected which is exactly what is defined by the first rule of the Table. Then, the third least significant bit is set implying that all addresses in the range]3,7](i.e.,]2²−1,2²⁺¹−1]) are to be accepted which is equivalent to the second rule of the Table, and so on for the remaining bits and rules. For example, all the rules in Table 1 in FIG. 8 are equivalent to interpreting precisely the instructions encoded in the following single BKAS notation “10.1.1.84|8”. Hereafter, two more examples are showcased to underline the great potential of the disclosed invention. All the rules in Table 4 in FIG. 11 are equivalent to a single rule expressed by the BKAS notation 10.1.0.171|8. The four rules in Table 5 in FIG. 12 are equivalent to the following two rules conveyed by the BKAS notation: 10.1.0.87|3 and 10.1.0.111|4. These examples demonstrate the significant potential of the BKAS addressing scheme in compressing filtering/routing rules.

In the adaptation mechanism, an alternative to implicit encoding of binary routing/filtering actions in BKAS notation is to use ternary routing/filtering actions with the third action as a default action. In this case, the two first actions are implicitly encoded in the BKAS notation and the IP packet routing/filtering/matching mechanism must be modified to handle a voting mechanism in which the third action (i.e., the default action) is taken by default when any of the fixed parts of the BKAS notation are mismatched.

Furthermore, the BKAS notation can be adapted to handle multiple routing/filtering actions by different manners:
By constructing the rules in the same manner as for CIDR/VLSM based rules:
   Format: “BKAS notation=>action”
   Examples: “10.1.0.87|3=>reject”, “10.1.0.111|4=>accept”, etc.
   Implications: In this scenario the specified action is applied to the matching intervals, and no action or a default action is associated with the mismatched intervals.
By grouping the actions into a set of disjoint binary actions:
   Format: “BKAS notation=>action/¬action” where “¬action” denotes the complementary action.—Examples: “10.1.0.87|3=>accept/deny”, “10.1.0.111|4=>forward/drop”, etc.
   Implications: This drastically reduces the number of rules. A default global action may or may not be adopted in this scenario. Note that this technique is only applicable if all the actions can be paired but one.
By grouping the actions into a set of ternary actions:
   Format: “BKAS notation=>action/¬action/∴action” where “∴action” denotes the default action.—Examples: “10.1.0.87|3=>accept/deny/forward”, “10.1.0.111|4=>accept/deny/forward”, etc.
   Implications: This substantially reduces the number of rules. Several ternary actions may or may not share the same default action. Excluding the default actions, the resulting set must consist of disjoint binary actions. Here, as stated above, the IP packet routing/filtering/matching mechanism must be modified to handle the default actions.
By encoding the actions into a binary mask:
   Format: “BKAS notation=>Actions encoded with binary masks”
   Examples: “10.1.0.87|3=>[accept/deny,101],[queue/go,010],[∴forward/drop]”, “10.1.0.111|4=>[accept,1000],[queue,0100],[forward,0010][∴reject]”, etc.
   Interpretation: Here the length of the action binary masks must match the specified length of the interval encoding part in the interval encoded addressing group. The binary masks can be specified in any numerical basis. Several strategies can be applied to resolve the action binary masks:
      One strategy can stipulate that if the BKAS notation contains more than one interval encoded addressing group, for each action associate the same number of binary masks. An action can be simple or a pair of binary actions. The default action is matched within the BKAS notation. For each other action the match can be resolved by taking the associated binary mask as the actual interval encoding part.
      Another strategy can instruct to use a unique binary mask per action or a pair of binary actions. The length of the binary mask is equal to the maximum length among the lengths of all interval encoded addressing groups in the BKAS notation. The default action is matched within the BKAS notation. For each other action and each interval encoded addressing group, the matching is done by resolving as an interval encoding the result of the “xor” between the action binary mask and the interval encoding part of the interval encoded addressing group.
   Implications: This extremely reduces the number of rules. However, the action encoding is tedious and error prone, and an action resolver is needed besides the IP packet routing/filtering/matching mechanism.
   Coherence check of action binary masks (bit-masks): Depending on the chosen strategy, the coherence check of action binary masks (bit-masks) may vary. Given the first mentioned strategy, the coherence check of action binary masks (bit-masks) with the associated BKAS notation is as simple as xor-ing all the binary masks (bit-masks) with each other and checking if all bits are equal to one or not (see the third example for security policy implementation below).

All the above discussed scenarios/techniques/mechanisms are given extensively and not exhaustively. All further extensions, adaptations, and adoptions of any of the specified material are covered by this disclosed invention.

Finally, a method highlighting the expressiveness of the BKAS notation with respect to security policies is introduced. A security policy is defined by a set of directives. For the sake of clarity and without loss of generality, it can be assumed that each directive must specify an address interval, and an action. Each directive may specify a certain number of exceptions. Given a particular directive, an exception must specify an address interval strictly included in the corresponding one in the directive. An exception overrides the action of its directive. Each exception can be overruled by a sub-directive which can be partially overridden by a subexception and so on given the inclusiveness of the domain of the lower level in the domain of high level. Once this definition is confronted with its counterpart of the BKAS notation, it is evident to assume that each directive can be expressed directly in BKAS notation. Precisely, it's important to note that if all the addressing intervals (including those of the exceptions) of a security policy conform to the form]2^{p}_1,2^{q}_1] where p<q, then the security policy can be conveyed by a single BKAS notation. Hereafter, the method of generating BKAS notations from a security policy is detailed:
Order the directives by their source address interval. If applicable, order the exceptions by the same criterium.
For each directive, if all the address intervals in the directive definition and its eventual exceptions are of the form]2^{p}_1,2^{q}_1] where p<q, then convert the directive to a single BKAS notation.
If several directives can be unified to form an overall source address interval of the form]2^{p}_1,2^{q}_1] where p<q, then unify them by finding common prefixes for their exceptions to minimize the number of BKAS notations.
Treat the remaining directives individually.

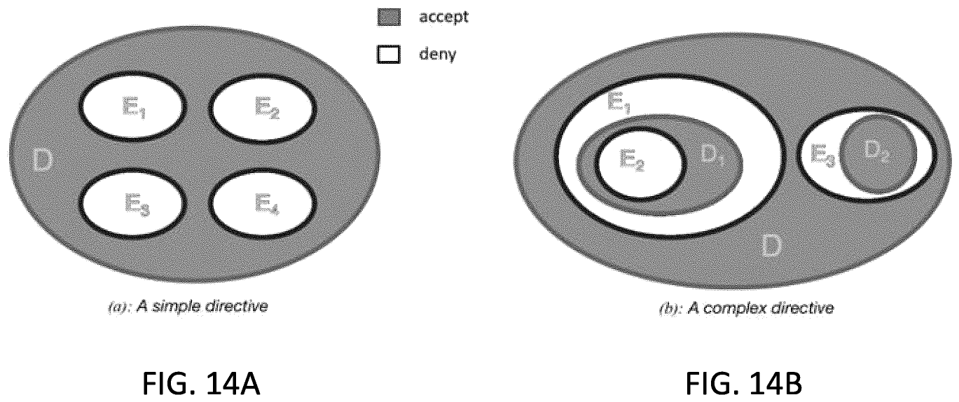

As an example, given the directive defined by FIG. 14A, the subsequent interval specification D=[0,255], E1=[0,1], E2=]3,7], E3=]15,31], E4=]63,127], and the routing prefix of 10.0.1, the single BKAS notation 10.0.1.170|8 covers it. (since the binary representation of 170 is 10101010). Note that five CIDR/VLSM notations are needed to cover the same directive.

Similarly, given the directive defined by FIG. 14B, the following interval specification D=]0003,7FFF], E1=]00FF;3FFF], D1=]03FF; 0FFF], E2=]07FF, 0FFF], E3=]000F, 007F], D2=]001F;003F] and the routing prefix 2001:b07f::, the equivalent BKAS notation is 2001:b07f::44ac|16 considering that 44ac has the binary representation 0100010010101100. Note that six CIDR notations are needed to cover the same directive.

Alternatively, reconsidering the directive defined by FIG. 14A with the same subsequent interval specification and the same routing prefix while associating the first two exceptions with the action reject and the last two exceptions with the action forward, the single rule “10.0.1.170|8=>[reject,5],[forward,80],[∴accept]” covers the modified directive by using the BKAS notation and the bit-mask encoding technique for actions according to the first proposed strategy. Here the default action is encoded within the BKAS notation, and the alternative actions are encoded through the bit-masks. The first bit-mask “5” (i.e. 101) encodes the intervals of the first two exceptions and the second bit-mask 80 (i.e. 1010000) encodes the intervals for the last two exceptions. The coherence check is “170 xor 5 xor 80=255” which proves that the encodings are complete and disjoint.

Once again, any similar methods that implement security policies to any kind of rules based on the BKAS notation are covered by this disclosed invention.

Generally spoken, the BKAS notation introduces an addressing scheme using an original disjoint interval encoding. The use of a disjoint interval encoding is important in the domain of addressing schemes in ICT Networking and Cybersecurity. Therefore, all alternative notations based on the usage of any kind of disjoint interval encoding for the purpose to build an addressing scheme are considered covered by this disclosed invention. All the alternative notations/extensions should be known as versions or subversions of the BKAS notation. Hereafter, several alternative notations, and extensions are described for the sake of expressing the extensiveness of this disclosed invention.

### BKAS Notation—Extended Subversion 1 (BKAS-ESV1): Subintervals Encoding (BKAS/SE)

Considering the original BKAS notation, a subinterval encoding is added to give system administrators more flexibility. Given the encoded intervals in the original notation sorted in decreasing order of length, for each interval in the form]2^{k}_1,2^{k+1}_1](k from 7 to 1 for IPv4 and from 15 to 1 for IPv6) associate k bits to encode its subintervals in the same manner as the original BKAS notation. The BKAS/SE notation can be derived as the original BKAS notation concatenated with a comma separated list of subintervals as enumerated encoding between brackets.

As an example conforming to IPv4 addressing architecture, the following BKAS/SE notation: “10.1.0.255|16 [96,48,27,12,6,2,1]” matches the following intervals]191,255],]159;191],]95,127],]79,95],]39,63],]31,35],]19,31],]9,15],]5,7], and]1;3]. For instance, the first sub-interval encoding “96” has “1100000” as a binary representation and is associated with the largest encoded interval]127,255]. The overall encoded sub-intervals are [128+0,128+1],]128+1,128+3],]128+3,128+7],]128+7,128+15],]128+15,128+31],]128+31,128+63],]128+63,128+127]. Since only the two most significant bits of the sub-interval encoding are set, only the two last intervals are matched (i.e.,]159;191] and]191,255]). Similarly, the second sub-interval encoding “48” has “110000” as a binary representation and is associated with the second largest encoded interval]63,127]. Therefore only the intervals]79,95] and]95,127] are matched. And so on, for the remaining sub-interval encodings.

This notation can be condensed in two manners: (1) enumerating the subinterval encodings for only the largest intervals and (2) concatenating the bits of all the subinterval encodings in one single encoding (28 bits for IPv4 and 120 bits for IPv6).

Throughout all the defined notations (i.e., original BKAS and its alternatives/extensions), it is important to note that they are easily interpreted/used into/within routing/filtering rules definitions by implementing security policies. No matter the action associated with the default directive of a security policy and the number of handled actions, an implementing strategy is straight forward. In particular, the detailed hardware and software implementations can be used in any of network/security device in order to provide significant enhancements.

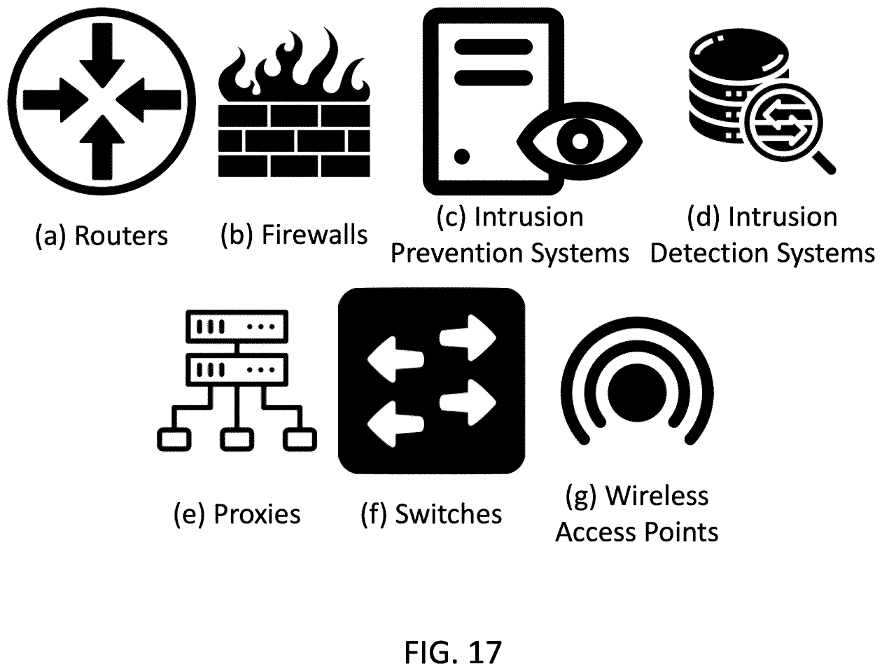

As depicted by FIG. 17, a list of some examples of such impacted equipment includes without limits: routers, firewalls, intrusion detection systems (IDS), intrusion prevention systems (IPS), network switches, and wireless access points. Additionally, any apparatus consisting of (1) a processing unit (e.g., FPGA, Microcontroller, Microprocessor, or System on Chip) to perform packet routing/filtering, (2) a storage memory for storing routing/filtering rules, (3) network interfaces, (4) network interface cards, (5) a switching hardware to manage networks with multiples segments or VLANs, (6) a power supply and (7) an enclosure or chassis can be impacted by the disclosed techniques. A firmware or an operating system can be installed on the apparatus. The matching algorithm can be implemented by hardware or by software for routing/filtering. The performance, efficiency, and effectiveness of these essential network and security components/apparatuses are enhanced by the disclosed techniques in the following ways:
A way to assign IP addresses and subnetworks by using the BKAS notation and the interval encodings in replacement of CIDR/VLSM as disclosed above.
The optimization of packet routing/filtering hardware/software by using the disclosed reference address matching logical circuit/algorithm or any of their derivative while taking advantage of the considerable reduction of the number of rules.
The enhanced support in configuring network and security equipment by efficiently implementing the security policies as discussed above.

The disclosed invention for an addressing scheme for any addressing architecture using an original disjoint interval encoding can be interpreted in various manners. The introduced addressing scheme is backward compatible with the CIDR/VLSM addressing scheme: every notation expressed in the latter can be easily translated to its semantically equivalent notation expressed in the former. Further methods implementing syntactically or semantically alternatives disjoint interval encoding techniques for the purpose of defining/extending any addressing scheme for any addressing architecture are also covered by this disclosed invention. Moreover, the disclosed invention encompasses any method and/or application adopting the BKAS notation to handle any kind of rules within any kind of applicable field (e.g., routing, filtering) using any kind of rule coherence checking strategies.

### BKAS Notation—Alternative Version 1 (BKAS-AV1): Almost the Same Length Disjoint Intervals Encoding (BKAS/ASLDIE).

Following the original BKAS notation, the BKAS/ASLDIE differs only in the interval interpretation for the interval encoding. According to BKAS/ASLDIE, the notation is resolved by following these axioms: Let “a” be a number expressed in any basis (e.g., decimal for IPv4, hexadecimal for IPv6) belonging to the interval [0,2ⁿ−1] where n is the number of bits of the addressing group (e.g., 8 for IPv4 and 16 for IPv6), “bₙ₋₁ bₙ₋₂ . . . b₁ b₀” is the binary representation of “a”, let k∈[0, n]. It follows that the interval encoded addressing group “a|k” must be divided into two parts: the most significant bits “bₙ₋₁ bₙ₋₂ . . . bₖ” considered as a fixed value (inexistent when k is equal to n) and the least significant bits “bₖ₋₁ . . . b₃b₂b₁b₀” interpreted as an interval encoding (inexistent when k is equal to 0). Each bit from the interval encoded part indicates whether a corresponding address interval is to be matched (the bit is set) or to be mismatched (the bit is unset). The address interval associated with a bit “bᵢ” (i∈[0,k−1]) within the interval encoded part is [i*p,(i*p)+(p−1)] for i∈[0,k−2] and [i*p,2^{k}−1] for i=(k−1) where p=2^{k} div k.

The BKAS/ASLDIE notation uses the same method for the conversion from CIDR/VLSM notation as the original BKAS notation. Therefore, every CIDR notation can be easily translated to its semantically equivalent BKAS/ASLDIE notation. However, an IP packet matching mechanism is needed and can be easily derived to handle the semantic difference in interval encoding interpretation.

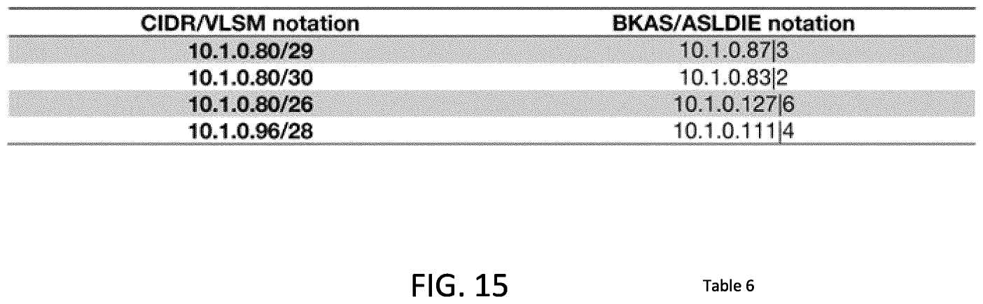

FIG. 15 is a list of examples of BKAS/ASLDIE alternative notation. For example, the BKAS/ASLDIE notation “10.1.0.8018” uses one interval encoded group. The resolving of the notation is performed as follows: Only IP addresses with routing prefixes “10.1.0” are matched by the BKAS/ASLDIE notation. The interval encoded group will only match IP addresses having their least significant address group in the ranges [128,159] and [192,223] within the already validated routing prefix. Indeed, the binary representation of 80 is “01010000” and the bit “b4” corresponds to the interval [128,159], and the bit “b₆” corresponds to the interval [192,223].

The BKAS/ASLDIE notation “10.1.0.8514” uses one interval encoded group. The binary representation of 85 is “01010101”. Then, the resolving of the notation is performed as follows: Only IP addresses with routing prefixes “10.1.0.85” followed by “0101” are matched by the BKAS/ASLDIE notation. The interval encoded group will only match IP addresses having their least significant address group in the ranges [0,3] and [8,11] within the already validated routing prefix. Indeed, the bit “b₀” corresponds to the interval [0,3], and the bit “b₂” corresponds to the interval [8,11].

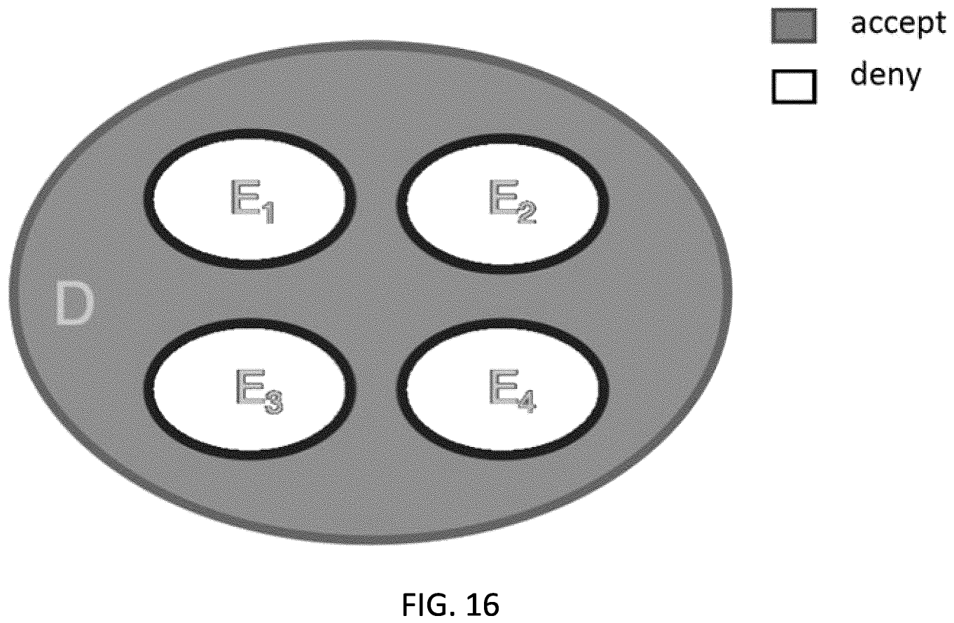

FIG. 16 is a drawing of a sample directive from sample security policies to be implemented in BKAS/ASLDIE notation. Consider the directive given in FIG. 16 where: D=[10.1.0.128, 10.1.0.255], E1=[10.1.0.128, 10.1.0.145], E2=[10.1.0.164, 10.1.0.181], E3=[10.1.0.200, 10.1.0.217] and E4=[10.1.0.236, 10.1.0.255].

The BKAS/ASLDIE notation corresponding to this directive is 10.1.0.4217. Indeed, the binary representation of 42 is “0101010”, and the most significant bit corresponding to the fixed value of the interval encoded addressing group is “1” and the least significant bits are “0101010” which corresponds to the three intervals: [18, 35], [54, 71] and [90, 107]. After adding the fixed bit “1”, we obtain: [146, 163], [182, 199] and [218, 235]. Since D=[10.1.0.128, 10.1.0.255], then we can easily show that the intervals of IP addresses with deny action are [10.1.0.128, 10.1.0.145], [10.1.0.164, 10.1.0.181], [10.1.0.200, 10.1.0.217] and [10.1.0.236, 10.1.0.255].

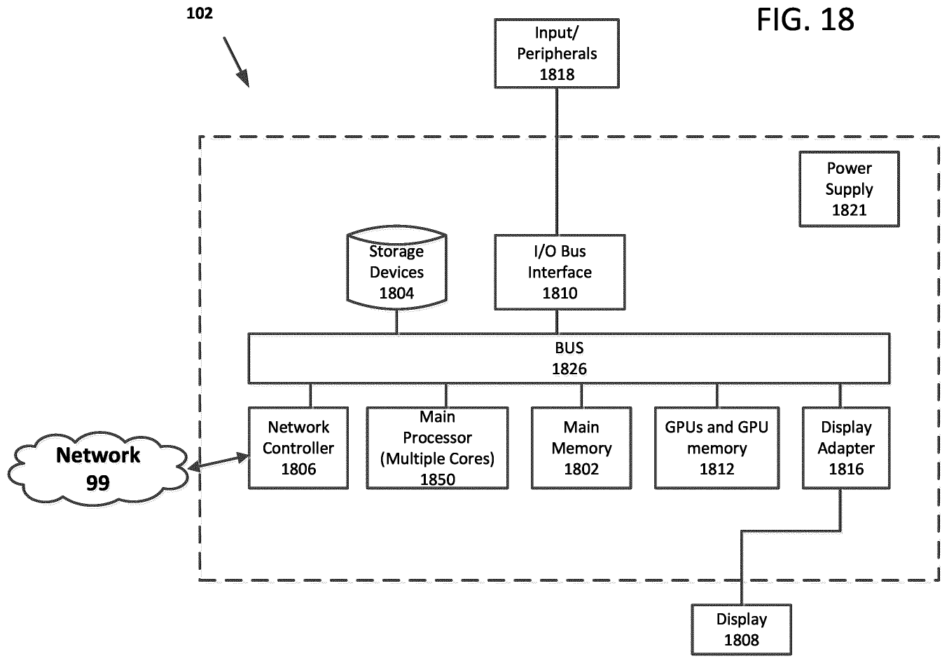

FIG. 18 is an illustration of a computer system having processing circuitry and program instructions for performing disclosed methods according to an exemplary aspect of the disclosure. The computer system may be any of a processing board, server, or workstation, running an operating system, for example Ubuntu Linux OS, Windows, a version of Unix OS, or Mac OS. The computer system 1800 may include one or more central processing units (CPU) 1850 having multiple cores (processing circuitry). The computer system 1800 may include a graphics board 1812 having multiple GPUs, each GPU having GPU memory. The graphics board 1812 may perform many of the mathematical operations of the disclosed filtering/routing methods. The computer system 1800 includes main memory 1802, typically random access memory RAM, which contains the software being executed by the processing cores 1850 and GPUs 1812, as well as a non-volatile storage device 1804 for storing data and the software programs (processing instructions). Several interfaces for interacting with the computer system 1800 may be provided, including an I/O Bus Interface 1810, Input/Peripherals 1818 such as a keyboard, touch pad, mouse, Display Adapter 1816 and one or more Displays 1808, and a Network Controller 1806 to enable wired or wireless communication through a network 99. The interfaces, memory and processors may communicate over the system bus 1826. The computer system 1800 includes a power supply 1821, which may be a redundant power supply.

In some embodiments, the computer system 1800 may include a server CPU and a graphics card by NVIDIA, with one or more GPUs.

The computer implemented methods disclosed herein may be performed by processing circuitry executing computer program instructions. The program instructions may be in machine code in accordance with the processing circuitry. Flowcharts are provided for the disclosed methods as a description of algorithms that can be implemented as hardware circuits and/or computer software.

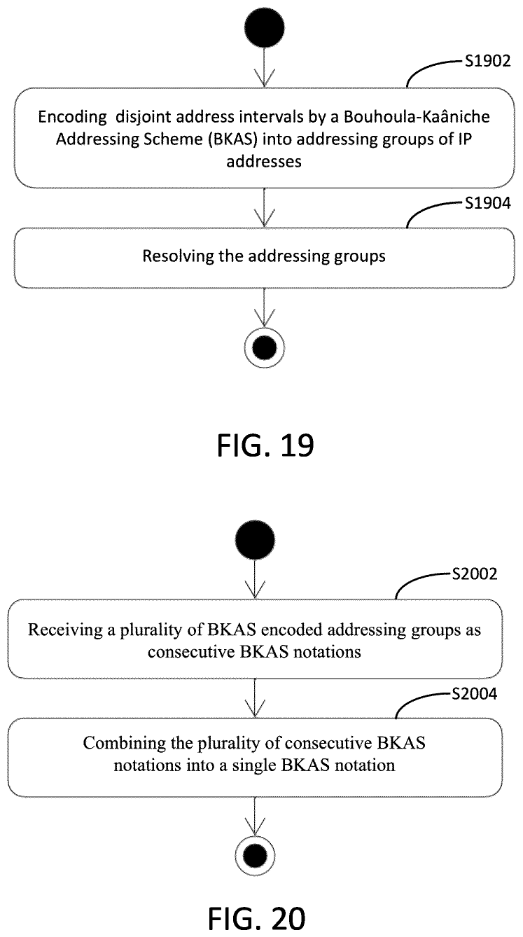

FIG. 19 is a flowchart for a method of encoding disjoint address intervals by a Bouhoula-Kaâniche Addressing Scheme (BKAS). A method of IP address allocating, can include step S1902 of encoding, by processing circuitry 1850, disjoint address intervals by a Bouhoula-Kaâniche Addressing Scheme (BKAS) into addressing groups of IP addresses, and step S1904 of resolving, by the processing circuitry, the addressing groups.

FIG. 20 is a flowchart for a method of combining consecutive BKAS notations. The method can include a step S2002 of receiving, by the processing circuitry 1850, a plurality of BKAS encoded addressing groups as consecutive BKAS notations, and step S2004 of combining, by the processing circuitry 1850, the plurality of consecutive BKAS notations into a single BKAS notation.

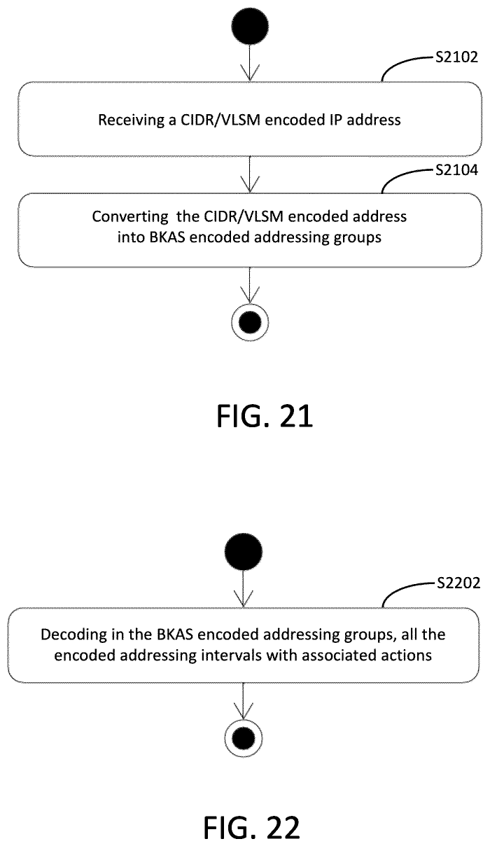

FIG. 21 is a flowchart for a method of converting a CIDR/VLSM encoded address into BKAS encoded addressing groups. The method can include a step S2102 of receiving, by the processing circuitry 1850, a CIDR/VLSM encoded IP address, and step S2104 of converting, by the processing circuitry, the CIDR/VLSM encoded address into BKAS encoded addressing groups.

FIG. 22 is a flowchart for a method of decoding, in BKAS encoded addressing groups, encoded addressing intervals with associated actions. The method can include a step S2202 of decoding, by the processing circuitry 1850, in the BKAS encoded addressing groups, all the encoded addressing intervals with associated actions.

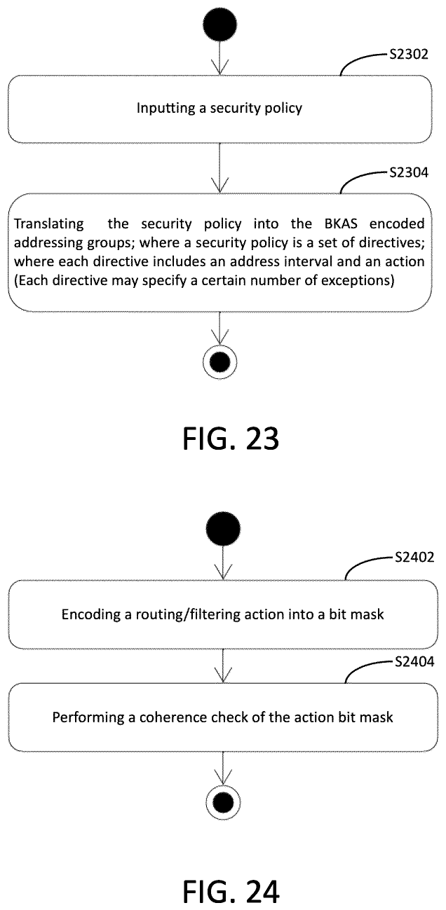

FIG. 23 is a flowchart for a method of translating a security policy into the BKAS encoded addressing groups. The method can include a step S2302 of inputting, by the processing circuitry 1850, a security policy, and step S2304 of translating, by the processing circuitry 1850, the security policy into the BKAS encoded addressing groups. The security policy is a set of at least one directive, and each directive includes an address interval and an action (Each directive may specify a certain number of exceptions).

FIG. 24 is a flowchart for a method of performing a coherence check of an action bit mask. The encoded addressing groups can include a routing/filtering action. The method can include a step S2402 of encoding, by the processing circuitry 1850, the action into a bit mask, and step S2404 of performing, by the processing circuitry 1850, a coherence check of the action bit mask.

It can thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

The above disclosure encompasses, but without limitation, the following embodiments:

(1) An IP address allocating apparatus, including means for encoding disjoint address intervals by a disjoint address interval encoding scheme into addressing groups of IP addresses, and resolution mechanism for resolving the addressing groups.

(2) The apparatus of feature (1), in which the disjoint address interval encoding scheme is Bouhoula-Kaâniche Addressing Scheme (BKAS).

(3) The apparatus of features (1) or (2), further including a default IP packet matching mechanism that uses match/mismatch actions.

(4) The apparatus of feature (3), in which the default IP packet matching mechanism is configured to perform a set of a plurality of alternative matching strategies, including modifying resolution of multiple interval-encoded addressing groups.

(5) The apparatus of feature (3), further including an adaptation mechanism, for IP routing/filtering, that overrides the match/mismatch actions with routing/filtering binary actions.

(6) The apparatus of feature (3), further including an adaptation mechanism, for IP routing/filtering, that overrides the IP packet matching mechanism by switching the encoding for interval match/mismatch, by using an alternative pair of binary actions, by using ternary actions where a third action is resolved as a default action, or/and multiple actions.

(7) The apparatus of feature (6), in which each of the IP packet matching mechanism and IP routing/filtering mechanism are logic circuits.

(8) The apparatus of feature (7), in which the logic circuit for the filtering mechanism is logically equivalent of an IP packet filter for a single addressing group.

(9) The apparatus of any of features (1) to (8), further including a filtering resolution mechanism for resolving the addressing groups for IP packet filtering.

(10) A method of IP address allocating, including encoding, by processing circuitry, disjoint address intervals by a Bouhoula-Kaâniche Addressing Scheme (BKAS) into addressing groups of IP addresses, and resolving, by the processing circuitry, the addressing groups.

(11) The method of feature (10), further including receiving, by the processing circuitry, a plurality of BKAS encoded addressing groups as consecutive BKAS notations, and combining, by the processing circuitry, the plurality of consecutive BKAS notations into a single BKAS notation.

(12) The method of features (10) or (11), further including receiving, by the processing circuitry, a CIDR/VLSM encoded IP address, converting, by the processing circuitry, the CIDR/VLSM encoded address into BKAS encoded addressing groups.

(13) The method of any of features (10) to (12), further including decoding, by the processing circuitry, in the BKAS encoded addressing groups, all the encoded addressing intervals with associated actions.

(14) The method of any of features (10) to (13), further including inputting, by the processing circuitry, a security policy, and translating, by the processing circuitry, the security policy into the BKAS encoded addressing groups, in which a security policy is a set of at least one directive, in which each directive includes an address interval and an action, in which each directive specifies a certain number of exceptions.

(15) The method of any of features (10) to (14), in which the encoded addressing groups include a routing/filtering action, further including encoding, by the processing circuitry, the action into a bit mask; and performing, by the processing circuitry, a coherence check of the action bit mask.

(16) A non-transitory computer-readable storage medium including computer executable instructions, wherein the instructions, when executed by a computer, cause the computer to perform a method for IP address allocation, the method including encoding disjoint address intervals by a Bouhoula-Kaâniche Addressing Scheme (BKAS) into addressing groups of IP addresses, and resolving the addressing groups.

(17) The non-transitory computer-readable storage medium of feature (16), in which the instructions are for a security application, in which the security application includes a plurality of security policies, the method further including generating BKAS encoded addressing groups from a security policy.

(18) The non-transitory computer-readable storage medium of feature (17), in which a security policy is a set of at least one directive, wherein each directive includes an address interval and an action, wherein each directive specifies a certain number of exceptions, in which the generating further includes ordering the directives by their source address interval, when two or more directives can be unified to form an overall source address interval, unify them by finding common prefixes for their exceptions to minimize a number of BKAS encoded addressing groups.

(19) The apparatus of feature (1), in which the encoding by the disjoint address interval encoding encodes a plurality of disjoint intervals into addressing groups.

(20) The apparatus of features (1) or (19), in which the disjoint address interval is divided into two parts, a most significant bits as a fixed value part and least significant bits as an interval encoding part.

(21) A computer system having processing circuitry and program instructions, in which the computer system runs an operating system, in which the computer system includes one or more central processing units having multiple cores, a graphics board having multiple GPUs, each GPU having GPU memory, wherein the graphics board performs mathematical operations of filtering/routing, a main memory, which contains the program instructions being executed by the processing cores and GPUs, a non-volatile storage device for storing data and the program instructions, and one or more Displays, wherein when the program instructions are executed by the processing circuitry perform a method including having a set of rules using BKAS addressing scheme.

It is also to be understood that the following figures and claims are intended to cover all of the generic and specific features of the invention herein described and all statements of the scope of the invention which, as a matter of language, might be said to fall therebetween.

What is claimed:

1. An IP address allocating apparatus, comprising:
means for encoding disjoint address intervals by a disjoint address interval encoding scheme into addressing groups of IP addresses;
and resolution mechanism for resolving the addressing groups.

2. The apparatus of claim 1, wherein the disjoint address interval encoding scheme is Bouhoula-Kaâniche Addressing Scheme (BKAS).

3. The apparatus of claim 1, further comprising:
a default IP packet matching mechanism that uses match/mismatch actions.

4. The apparatus of claim 3, wherein the default IP packet matching mechanism is configured to perform a set of a plurality of alternative matching strategies, including modifying resolution of multiple interval-encoded addressing groups.

5. The apparatus of claim 3, further comprising:
an adaptation mechanism, for IP routing/filtering, that overrides the match/mismatch actions with routing/filtering binary actions.

6. The apparatus of claim 3, further comprising:
an adaptation mechanism, for IP routing/filtering, that overrides the IP packet matching mechanism by switching the encoding for interval match/mismatch, by using an alternative pair of binary actions, by using ternary actions where a third action is resolved as a default action, or/and multiple actions.

7. The apparatus of claim 6, wherein each of the IP packet matching mechanism and IP routing/filtering mechanism are logic circuits.

8. The apparatus of claim 7, wherein the logic circuit for the filtering mechanism is logically equivalent of an IP packet filter for a single addressing group.

9. The apparatus of claim 1, further comprising:
a filtering resolution mechanism for resolving the addressing groups for IP packet filtering.

10. A method of IP address allocating, comprising:
encoding, by processing circuitry, disjoint address intervals by a Bouhoula-Kaâniche Addressing Scheme (BKAS) into addressing groups of IP addresses; and
resolving, by the processing circuitry, the addressing groups.

11. The method of claim 10, further comprising:
receiving, by the processing circuitry, a plurality of BKAS encoded addressing groups as consecutive BKAS notations; and
combining, by the processing circuitry, the plurality of consecutive BKAS notations into a single BKAS notation.

12. The method of claim 10, further comprising:
receiving, by the processing circuitry, a CIDR/VLSM encoded IP address,
converting, by the processing circuitry, the CIDR/VLSM encoded address into BKAS encoded addressing groups.

13. The method of claim 10, further comprising:
decoding, by the processing circuitry, in the BKAS encoded addressing groups, all the encoded addressing intervals with associated actions.

14. The method of claim 10, further comprising:
inputting, by the processing circuitry, a security policy; and
translating, by the processing circuitry, the security policy into the BKAS encoded addressing groups,
wherein a security policy is a set of at least one directive,
wherein each directive includes an address interval and an action, and
wherein each directive specifies a certain number of exceptions.

15. The method of claim 10, wherein the encoded addressing groups include a routing/filtering action, further comprising:
encoding, by the processing circuitry, the action into a bit mask; and
performing, by the processing circuitry, a coherence check of the action bit mask.

16. A non-transitory computer-readable storage medium including computer executable instructions, wherein the instructions, when executed by a computer, cause the computer to perform a method for IP address allocation, the method comprising:
encoding disjoint address intervals by a Bouhoula-Kaâniche Addressing Scheme (BKAS) into addressing groups of IP addresses; and
resolving the addressing groups.

17. The non-transitory computer-readable storage medium of claim 16, wherein the instructions are for a security application,
wherein the security application includes a plurality of security policies,
the method further comprising generating BKAS encoded addressing groups from a security policy.

18. The non-transitory computer-readable storage medium of claim 17, wherein a security policy is a set of at least one directive,
wherein each directive includes an address interval and an action, wherein each directive specifies a certain number of exceptions,
wherein the generating further comprises
ordering the directives by their source address interval;
when two or more directives can be unified to form an overall source address interval, unify them by finding common prefixes for their exceptions to minimize a number of BKAS encoded addressing groups.

19. The apparatus of claim 1, wherein the encoding by the disjoint address interval encoding encodes a plurality of disjoint intervals into addressing groups.

20. The apparatus of claim 1, wherein the disjoint address interval is divided into two parts, a most significant bits as a fixed value part and least significant bits as an interval encoding part.

21. A computer system having processing circuitry and program instructions,
wherein the computer system runs an operating system,
wherein the computer system includes
one or more central processing units having multiple cores, a graphics board having multiple GPUs, each GPU having GPU memory, wherein the graphics board performs mathematical operations of filtering/routing, a main memory, which contains the program instructions being executed by the processing cores and GPUs,
a non-volatile storage device for storing data and the program instructions, and one or more Displays, wherein when the program instructions are executed by the processing circuitry perform a method comprising:
having a set of rules using BKAS addressing scheme.
